(19) United States
(12) Patent Application Publication
(10) Pub. No.: US 2020/0242929 A1
(43) Pub. Date: Jul. 30, 2020

(54) SYSTEMS AND METHODS FOR A TRANSPORTATION NETWORK

(71) Applicant: Honda Motor Co., Ltd., Tokyo (JP)

(72) Inventors: Michael T. Sailer, Whittier, CA (US); Nathan G. Brown, Long Beach, CA (US); Katie C. Wallace, Long Beach, CA (US); Annika E. Nordlund-Swenson, Seattle, WA (US); Thomas More Grimer, Chesham (GB)

(21) Appl. No.: 16/258,019

(22) Filed: Jan. 25, 2019

(51) Int. Cl. G08G 1/0968; B60L 53/66; B62D 47/00; G05D 1/00

(52) U.S. Cl. CPC G08G 1/096816; B60L 53/66; G05D 2201/0213; G05D 1/0088; B62D 47/006

(57) ABSTRACT

A transportation network system for providing a transportation using a modular vehicle is provided. According to one or more aspects, the transportation network system for providing a modular vehicle is provided. The modular vehicle includes a parent vehicle and one or more child vehicles. The transportation network system comprises a connection module, a logistical module, and a charging module. The connection module identifies a proximate vehicle and provides the proximate vehicle connection instructions to connect the proximate vehicle to the modular vehicle as a child vehicle. The logistical module provides services to the child vehicle. The charging module manages a charging source. The charging module initiates a charge to the child vehicle from the parent vehicle.

### BACKGROUND

Autonomous vehicles use sensors to perceive their environment and then navigate using the sensor information. For example, an autonomous vehicle may be able to path plan without input from a vehicle occupant, thereby easing the demands on the vehicle occupant and improving the operating experience. However, the vehicle occupant may still find themselves sitting in traffic congestion on the roadways.

### BRIEF DESCRIPTION

According to one or more aspects, a transportation network system for providing a modular vehicle is provided. The modular vehicle includes at least one parent vehicle and one or more child vehicles. The transportation network system comprises a connection module, a logistical module, and a charging module. The connection module identifies a proximate vehicle and provides the proximate vehicle with connection instructions to connect the proximate vehicle to the modular vehicle as a child vehicle. The logistical module provides services to the child vehicle. The charging module manages a charging source. The charging module facilitates a charge to one or more child vehicles from the charging source through a parent vehicle.

According to other aspects, a transportation network system for providing a modular vehicle having a parent vehicle and one or more child vehicles is provided. The transportation network system comprises a connection module, a logistical module, and a charging module. The connection module identifies a proximate vehicle and provides the proximate vehicle with connection instructions to connect the proximate vehicle to the modular vehicle as a child vehicle. The logistical module provides services to the child vehicle. The charging module is connected to a charging source and initiates a charge to the child vehicle from the charging source.

According to yet further aspects, a method for providing a transportation network using a modular vehicle is described. The method includes identifying a proximate vehicle. The method further includes providing the proximate vehicle with connection instructions to connect the proximate vehicle to the modular vehicle as a child vehicle. The method also includes providing navigational services to the child vehicle. The method further includes providing a charge to the child vehicle from the parent vehicle.

### BRIEF DESCRIPTION OF THE DRAWINGS

FIG. 1 is a schematic diagram of an operating environment for implementing systems and methods for providing a transportation network according to an exemplary embodiment.

FIG. 2 is a schematic diagram a modular vehicle including a parent vehicle and child vehicles according to an exemplary embodiment.

FIG. 3 is a schematic illustration of a parent vehicle of the modular vehicle according to an exemplary embodiment.

FIG. 4 is a schematic diagram of a first vehicle of the modular vehicle according to an exemplary embodiment.

FIG. 5 is a schematic diagram of a second vehicle of the modular vehicle according to an exemplary embodiment.

FIG. 6 is a schematic diagram of a third vehicle of the modular vehicle according to an exemplary embodiment.

FIG. 7 is a process flow diagram of a method for providing a transportation network according to an exemplary embodiment.

### DETAILED DESCRIPTION

Public transportation uses publicly available vehicles to transport vehicle occupants, and can reduce traffic congestion as multiple vehicle occupants are able to take advantage of the publically available vehicles. Publically available vehicles include any vehicles that are available for public use. Publically available vehicles may be operated on a schedule, according to known routes, and/or for remuneration. For example, publically available vehicles may include, but are not limited to, buses, trains, trams, subway, light rail, taxi, and ride-sharing, among others. Because publically available vehicles work individually and/or combination to move multiple people, public transportation can reduce traffic congestion.

Generally, the systems and methods disclosed herein combine the benefits of public transportation with operating advantages of the autonomous vehicles to provide a transportation network. The transportation network allows child vehicles, having some level of autonomy, to connect and disconnect to at least one parent vehicle in motion. The at least one parent and child vehicles may operate, at least partially, autonomously. For example, a child vehicle may be able to dock to a parent vehicle autonomously. The parent vehicle may provide services to the child vehicles when connected. For example, the parent vehicle may provide child vehicle(s) with logistical services, navigation, power, electrical charging, and user services. The user services may facilitate users requesting, scheduling, and moving among child vehicles as well as delivery services, for example, package delivery, takeout delivery, etc.

### DEFINITIONS

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), cloud computing communication, a point-to-point system, a circuit switching system, a packet switching system, among others.

A “database,” as used herein can refer to table, a set of tables, a set of data stores and/or methods for accessing and/or manipulating those data stores. Some databases can be incorporated with a disk as defined above.

A “disk,” as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

“Mobility device,” as used herein, is any device designed to assist a user's mobility. Exemplary mobility devices can include, but are not limited to manual self-propelled wheelchairs, powered wheelchairs, mobility scooters, single-arm drive wheelchairs, reclining tilting wheelchairs, standing wheelchairs, sports wheelchairs, wheelchair stretchers, all-terrain wheelchairs, self-balancing wheelchairs, smart wheelchairs, body-powered prostheses, robotic prostheses, smart prostheses, movement assist apparatuses, stair climbing aids, lifts, walkers, mobility scooters, balance bicycles, carts, strollers, and power braces. In some embodiments, the mobility device can include various sensors for sensing and determining various parameters of a user. For example, location, motion, and physiological parameters, among others. Some mobility devices have user input and output functionality.

A “module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection,” or a connection by which entities are “operably connected,” is one in which signals, physical communications, and/or logical communications can be sent and/or received. An operable connection can include a wireless interface (e.g., for wireless charging), a physical interface, a data interface, and/or an electrical interface.

A “portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

A “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “vehicle,” as used herein, refers to any moving vehicle that is capable of carrying one or more human occupants, cargo, conveyance device, etc. and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more human occupants and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle may or may not carry one or more human occupants. Further, the term “vehicle” can include vehicles that are automated or non-automated with pre-determined paths or free-moving vehicles.

A “vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

A “vehicle occupant,” as used herein can include, but is not limited to, one or more biological beings located in the vehicle. The vehicle occupant can be a driver or a passenger of the vehicle. The vehicle occupant can be a human (e.g., an adult, a child, an infant) or an animal (e.g., a pet, a dog, a cat).

### System Overview

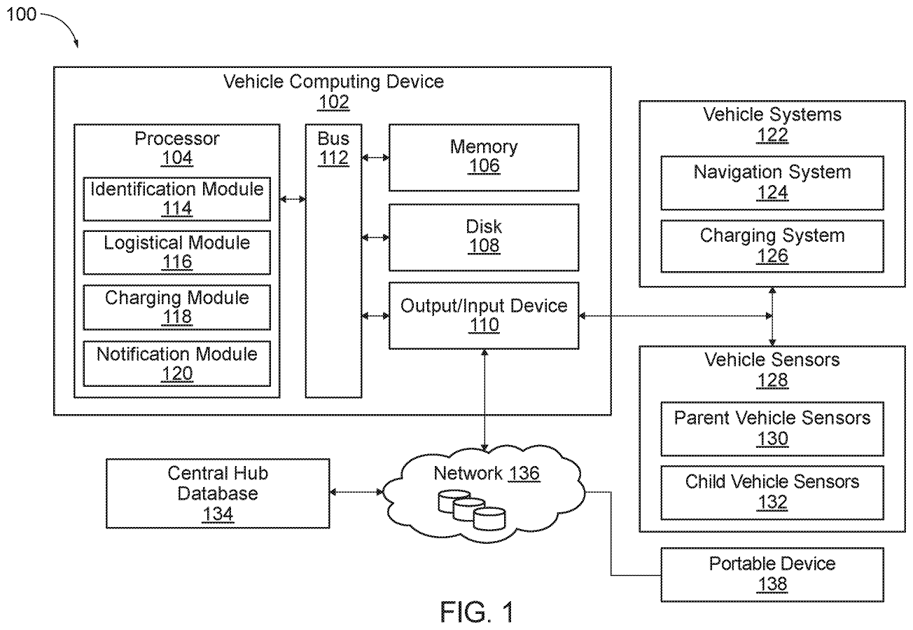

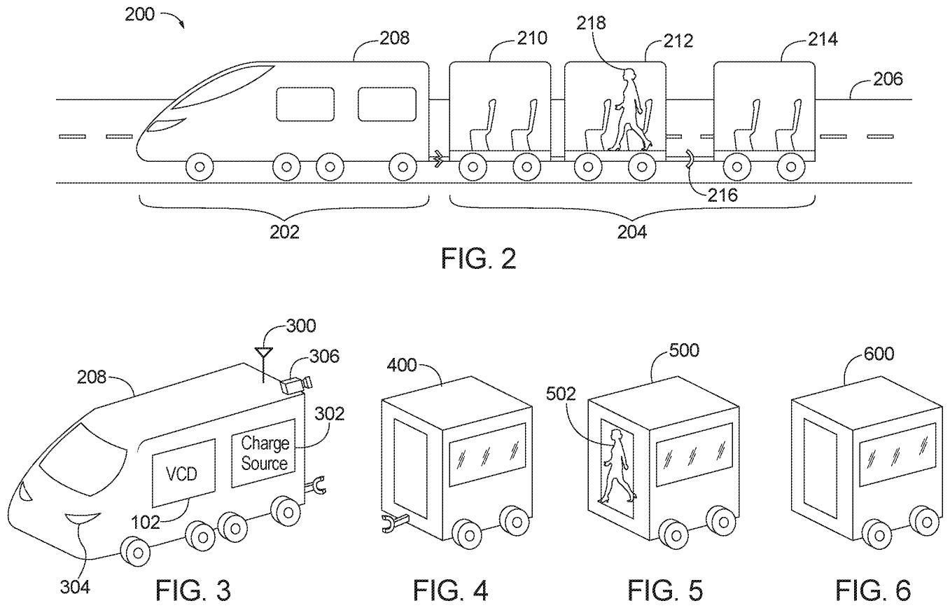

Referring now to the drawings, wherein the showings are for purposes of illustrating one or more exemplary embodiments and not for purposes of limiting same, FIG. 1 is a schematic diagram of an operating environment 100 for providing a transportation network. The components of operating environment 100, as well as the components of other systems, hardware architectures, and software architectures discussed herein, can be combined, omitted, or organized into different architectures for various embodiments. Further, the components of the operating environment 100 can be implemented with or associated with a modular vehicle 200, as shown in FIG. 2, having a locomotive portion 202 and a member portion 204, traversing a roadway 206. The locomotive portion 202 includes at least one parent vehicle, such as the parent vehicle 208. The member portion 204 includes one or more child vehicles, such as a first child vehicle 210 and a second child vehicle 212. Therefore, while two child vehicles are shown more or fewer may utilize the systems and methods described herein. Furthermore, the illustrated vehicles, such as the parent vehicle 208, the first child vehicle 210, and the second child vehicle 212 are merely exemplary and may be different sizes, styles, powered, etc. For example, the first child vehicle 210 may accommodate a single vehicle occupant or a single item while the second child vehicle 212 may accommodate fifty vehicle occupants or a large amount of cargo. Additionally or alternatively, the vehicles may have different fittings for accommodating different types of vehicles. In another embodiment, the member portion 204 may include a parent vehicle acting as a child vehicle. Accordingly, a vehicle's designation as a parent vehicle or a child vehicle is defined by its relationship to the other vehicles traveling with the modular vehicle 200. In one embodiment, the first child vehicle 210 may be a parent vehicle acting as a child vehicle, but suppose the first child vehicle 210 and the second child vehicle 212 disengage from the modular vehicle 200, then the first child vehicle 210 may resume a parent designation.

In the illustrated embodiment of FIG. 1, the operating environment 100 includes a vehicle computing device (VCD) 102 with provisions for processing, communicating, and interacting with various components of a vehicle and other components of the operating environment 100. In one embodiment, the VCD 102 can be implemented with the parent vehicle 208 and/or a child vehicle 210 or 212, for example, as part of a telematics unit, a head unit, a navigation unit, an infotainment unit, an electronic control unit, among others. In other embodiments, the components and functions of the VCD 102 can be implemented remotely from a vehicle, for example, with a portable device 138 or another device connected via a network (e.g., a network 136).

Generally, the VCD 102 includes a processor 104, a memory 106, a disk 108, and an input/output (I/O) interface 110, which are each operably connected for computer communication via a bus 112 and/or other wired and wireless technologies. The I/O interface 110 provides software and hardware to facilitate data input and output between the components of the VCD 102 and other components, networks, and data sources, which will be described herein. Additionally, the processor 104 includes a connection module 114, a logistical module 116, a charging module 118, and a notification module 120, for providing a transportation network facilitated by the components of the operating environment 100.

The VCD 102 is also operably connected for computer communication (e.g., via the bus 112 and/or the I/O interface 110) to one or more vehicle systems 122. The vehicle systems 122 can include, but are not limited to, any automatic or manual systems that can be used to enhance the vehicle, driving, and/or safety. Here, the vehicle systems 122 include a navigation system 124 and a charging system 126 according to an exemplary embodiment. The navigation system 124 stores, calculates, and provides route and destination information and facilitates features like turn-by-turn directions. The charging system 126 determines the relative charging capability between the parent vehicle 208 and the one or more child vehicles of the member portion 204 and facilitates charging of the one or more child vehicles. In some embodiment, the charging system 126 may be distributed over the parent vehicle 208, the first child vehicle 210, the second child vehicle 212, and/or the proximate vehicle 214. Additionally or alternatively, the charging system 126 may include a plurality of charging systems.

The vehicle systems 122 include and/or are operably connected for computer communication to the vehicle sensors 128. The vehicle sensors 128 provide and/or sense information associated with the vehicle, the vehicle environment, the vehicle systems 122, vehicle occupants, and/or cargo. The vehicle sensors 128 can include, but are not limited to, parent vehicle sensors 130 associated with the parent vehicle 208 and/or child vehicle sensors 132 that collect data regarding child vehicles, such as the first child vehicle 210 and the second child vehicle 212, that are proximate to the modular vehicle 200 and the child vehicles that are connected to the modular vehicle 200. The vehicle sensors 128 can further collect data regarding proximate vehicles, such as proximate vehicle 214.

The vehicle sensors 128 can include, but are not limited to, environmental sensors, vehicle speed sensors, accelerator pedal sensors, brake sensors, throttle position sensors, wheel sensors, anti-lock brake sensors, camshaft sensors, among others. In some embodiments, the vehicle sensors 128 are incorporated with the vehicle systems 122. For example, one or more vehicle sensors 128 may be incorporated with the navigation system 124 to monitor characteristics of the parent vehicle 208, the first child vehicle 210, the second child vehicle 212, and/or the proximate vehicle 214 such as location and speed. The vehicle sensors 128 can also include image sensors, such as cameras, optical sensors, radio sensors, etc. mounted to the interior or exterior of the modular vehicle 200 and light sensors, such as light detection and ranging (LiDAR) sensors, radar, laser sensors etc.

The vehicle sensors 128 can include sensors external to the modular vehicle 200, accessed, for example, via the network 136. For example, the vehicle sensors 128 may include external cameras, radar and laser sensors on other vehicles in a vehicle-to-vehicle network, street cameras, and surveillance cameras, among others. The vehicle sensors 128 monitor the environment of the modular vehicle 200 to detect the presence of proximate vehicles. Additionally, the vehicle sensors 128 may detect characteristics of the one or more proximate vehicles, such as location and speed of the proximate vehicles, as well as relative characteristics of the parent vehicle 208 and the proximate vehicle 214, such as relative distance and speed between the parent vehicle 208 and the proximate vehicle 214.

Accordingly, the vehicle sensors 128 are operable to sense a measurement of data associated with the modular vehicle 200, the vehicle environment, the vehicle systems 122, the parent vehicle 208, and/or the proximate vehicles and generate a data signal indicating said measurement of data. These data signals can be converted into other data formats (e.g., numerical) and/or used by the vehicle systems 122 and/or the VCD 102 to generate other data metrics and parameters. It is understood that the vehicle sensors 128 can be any type of sensor, for example, acoustic, electric, environmental, optical, imaging, light, pressure, force, thermal, temperature, proximity, among others.

The VCD 102 is also operatively connected for computer communication to the network 136 and a central hub database 134. It is understood that the connection from the I/O interface 110 to the network 136, and the central hub database 134 can be facilitated in various ways. For example, through a network connection (e.g., wired or wireless), a cellular data network from a portable device (not shown), a vehicle to vehicle ad-hoc network (not shown), an in-vehicle network (not shown), among others, or any combination of thereof. In some embodiments, the central hub database 134 could be located on-board the vehicle, at for example, the memory 106 and/or the disk 108. In other embodiments, the central hub database 134 can be distributed in one or more locations.

The network 136 is, for example, a data network, the Internet, a wide area network or a local area network. The network 136 serves as a communication medium to various remote devices (e.g., databases, web servers, remote servers, application servers, intermediary servers, client machines, other portable devices). In some embodiments, the central hub database 134 may be included in the network 136, accessed by the VCD 102 through the network 136, and/or the network 136 can access the central hub database 134. Thus, in some embodiments, the VCD 102 can obtain data from the central hub database 134 via the network 136. The transportation network includes the VCD 102 being able to transmit and receive information directly or indirectly to and from the vehicle sensors 128, the vehicles systems, the portable device 138, the parent vehicle 208, one or more child vehicles including the first child vehicle 210 and the second child vehicle 212, and/or the proximate vehicle 214, over the network 136.

### Application of Systems and Methods

The application of systems and methods are described with respect to a modular vehicle 200. The embodiments are exemplary in nature and are not provided to be limiting. For example, an embodiment in which a parent vehicle 208 hosts the VCD 102 does not imply that the child vehicles 400, 500, and 600 are not host vehicles. Accordingly, the disclosed features and functions, or alternatives or varieties thereof, of the host vehicle may be implemented by either a parent vehicle or a child vehicle.

FIG. 1 is a schematic diagram of an operating environment 100 for implementing systems and methods for providing a transportation network for a modular vehicle 200. The modular vehicle 200 may be configured for any number of terrains. For example, as shown in FIG. 2, the modular vehicle 200 may traverse a roadway 206. In another embodiment, the modular vehicle 200 may be configured to use a rail system (e.g., light rail, heavy rail, electric rail, etc.).

The modular vehicle 200 includes a locomotive portion 202 and a member portion 204 populated by a number of vehicles. The vehicles of the modular vehicle 200 are categorized as a parent vehicle, such as parent vehicle 208 or as a child vehicle, such as the first child vehicle 210. Parent vehicles populate the locomotive portion 202 and the child vehicles populate the member portion 204. In one embodiment, the member portion 204 is situated behind the locomotive portion 202 given the direction of motion. This embodiment is exemplary and other configurations of parent vehicles and child vehicles may be used. For example, the member portion 204 may situated in front of the locomotive portion 202 given the direction of motion. In another embodiment, the parent vehicles and child vehicles may be patterned. For example, every fifth vehicle of the modular vehicle 200 may be a parent vehicle and the remaining vehicles may be child vehicles.

As described above, the VCD 102 includes the processor 104 having the connection module 114. The connection module 114 identifies at least one proximate vehicle 214 traveling a path that is commensurate with the route of the modular vehicle 200. The proximate vehicle 214 is not connected to the modular vehicle 200. For example, the proximate vehicle 214 may be approaching the modular vehicle 200 on the roadway 206 in a lane having traffic moving in the same direction as the modular vehicle 200.

The connection module 114 may identify proximate vehicle using data received from the vehicle systems 122 and the vehicle sensors 128. The parent vehicle 208 having parent vehicle sensors 130 may include optical sensors and image sensors is shown in FIG. 3. The parent vehicle 208 has a number of parent vehicle sensors 130, such as RADAR 304. The parent vehicle 208 may also include at least one image sensor, such as camera 306. The camera 306 may be mounted to the interior or exterior of the parent vehicle 208. The camera 306 may detect visible and infra-red light from the proximate vehicles. The camera 306 may also detect a pattern of light in images processed by the connection module 114 or a vehicle system 122. The pattern of light may indicate that at least one proximate vehicle has illuminated a turn signal or the end of lane as the markings on the pavement stop.

Returning to FIG. 1, in some embodiments, the connection module 114 may identify proximate vehicles in real-time and/or store, aggregate, and track previously identified proximate vehicles. In another embodiment, the connection module 114 may receive information about proximate vehicles from remote sensors (accessed, for example, via the network 136), for example, external cameras, radar and laser sensors on other vehicles, such as the proximate vehicles, in a vehicle-to-vehicle network, street cameras, surveillance cameras, in-pavement sensors, among others.

The connection module 114 may additionally identify one or more connection indicators that indicate that a proximate vehicle may be about to attempt to connect to the modular vehicle 200. The connection indicators may include a connection signal being transmitted from the transmitter 300 of the parent vehicle 208 and received from the proximate vehicle 214 including a request to join the modular vehicle 200. The connection indicators may also include the proximate vehicle 214 moving in-line with the modular vehicle 200, the proximate vehicle 214 entering the lane of the roadway 206 that modular vehicle 200 is traveling in, a turn signal illumination on a proximate vehicle 214, proximity of the proximate vehicle 214 to the modular vehicle 200, etc. For example, the parent vehicle 208 of the modular vehicle 200 may detect a turn signal being illuminated on a proximate vehicle 214.

The connection module 114 provides the proximate vehicle 214 with connection instructions to connect the proximate vehicle 214 to a parent vehicle 208 of the modular vehicle 200. The connection module 114 communicates the connection instructions to the proximate vehicle 214 through a network connection (e.g., wired or wireless), a cellular data network from a portable device (not shown), a vehicle to vehicle ad-hoc network (not shown), an in-vehicle network (not shown), among others, or any combination of thereof. In another embodiment, the connection module may trigger the central hub database 134 with a connection signal that causes the central hub database 134 to transmit the connection instructions to the proximate vehicle 214.

The connection instructions provide information for the proximate vehicle 214 to join the modular vehicle 200 in the member portion 204 as a child vehicle. The connection instructions may include, for example, driving parameters such as a steering angle, a braking force, parent vehicle velocity, proximate vehicle velocity, following distance of the proximate vehicle 214, or a change in steering angle over time during a driving maneuver, a candidate join location for the proximate vehicle 214 to connect to the modular vehicle 200, etc.

In some embodiments, the connection between the proximate vehicle 214 and the modular vehicle 200 is a physical connection. For example, the connection instructions may include a docking procedure. Docking as used herein describes both physical and wireless docking. For example, docking may be a manner in which parent and child vehicles communicate and coordinate travel. For example, the first child vehicle 210 may not dock with the parent vehicle 208 if vehicle occupants and cargo do not have to be exchanged. Instead, the child vehicle 210 may dock wirelessly with the parent vehicle 208, for example to send and receive navigational data. Likewise, the child vehicle 210 may dock wirelessly with the parent vehicle 208 to provide or receive a wireless charge utilizing the wireless interface. In another example, the docking procedure may include timing for executing a mating procedure using physical connection assemblies including a connection assembly 216 of the proximate vehicle 214 and the connected vehicles of the modular vehicle 200. When coupled, the connection assemblies of the proximate vehicle 214 and a vehicle of the modular vehicle 200 cause the proximate vehicle to become a member of the modular vehicle 200. Accordingly, the proximate vehicle 214 becomes a child vehicle when connected to the modular vehicle 200.

The logistical module 116 of the processor 104 communicates with the child vehicles of the member portion 204 of the modular vehicle 200. The logistical module 116 provides services to the first child vehicle 210 and the second child vehicle 212 in the member portion 204 using the vehicle systems 122. For example, the logistical module 116 may use the navigation system 124 of the modular vehicle 200 to provide navigational data to the first child vehicle 210 and the second child vehicle 212. The navigational data may include path planning for the first child vehicle 210 and the second child vehicle 212. Therefore, once the first child vehicle 210 and the second child vehicle 212 are connected by the connection module 114, the logistical module 116 can identify a redistribution of cargo and the vehicle occupants across the first child vehicle 210 and the second child vehicle 212. The logistical module 116 then generates navigational data that may cause the first child vehicle 210 and the second child vehicle 212 to be disconnected and redeployed on a more efficient route without stopping the modular vehicle.

The logistical module 116 performs path planning based on the vehicle data of the parent vehicle 208, the vehicle data of the first child vehicle 210 and the second child vehicle 212, and the user data of the vehicle occupants, such as vehicle occupant 218. The vehicle data may include the range of the corresponding vehicle, the availability of the vehicle, the origin of the vehicle, and the destination of the vehicle among others. The vehicle data may also include the current manifest of the first child vehicle 210 and the second child vehicle 212. For example, the vehicle data may identify the presence of vehicle occupants and/or cargo, the destination thereof, the origin thereof, the amount of time that the vehicle occupants, cargo have been traveling since embarking, etc. The user data of the vehicle occupant 218 may include the desired occupancy of a vehicle, length of travel, distance of route, preferences, environmental options (e.g., temperature, audio control, light control, low stimulus environment, etc.), and personal mobility options (e.g. mobility device accessible, mobility device availability, charging for a mobility device, etc.).

The logistical module 116 provides the path planning to the first child vehicle 210 and the second child vehicle 212 as navigational data. Because the first child vehicle 210 and the second child vehicle 212 are capable of operating independently, the child vehicles can disconnect and reconnect from the parent vehicle 208 and other child vehicles. Therefore, the logistical module 116 can determine an efficient route for the cargo and/or vehicle occupants with respect to the modular vehicle 200 as well as the first child vehicle 210 and the second child vehicle 212, and provide navigational data accordingly.

The navigational data may generally include a manner for arriving at a destination according to the performed path planning. For example, the navigational data may include, but are not limited to, at least a portion of the route, the origin, the destination, address, coordinates, a point of interest, one or more roadway names, directions, a waypoint, directions, and headings, among others. The navigational data may also be associated with an event, invitation, ticket, or other item associated with a time or location. For example, the navigational data may include a time of arrival, estimated time of arrival, appointment time, the time an event is scheduled to start, a time of departure, and the duration of travel, among others. Furthermore, the navigational data may be based on real time traffic data. For example, in one embodiment, the navigation data may be based on real-time traffic data to calculate a fastest route.

The navigational data allows a child vehicle to navigate a planned path whether the child vehicle is connected to the modular vehicle or not. For example, suppose that a parent vehicle 208, as shown in FIG. 3, is circling a city (not shown) and a first vehicle 400 shown in FIG. 4, a second vehicle 500 shown in FIG. 5, and a third vehicle 600 shown in FIG. 6, are coming into the city from different surrounding areas. The vehicles 400, 500, and 600 are considered proximate vehicles until the vehicles have been connected to the parent vehicle 208 on this trip. Once connected to the parent vehicle 208, by way of the modular vehicle 200, the vehicles 400, 500, and 600 are deemed child vehicles, like the first child vehicle 210 and the second child vehicle 212, shown in FIG. 2. Accordingly, the designation of the vehicles 400, 500, and 600 changes based on the vehicles 400, 500, and 600 relationship with the parent vehicle 208 of the modular vehicle 200.

In some embodiments, the child vehicles are still considered child vehicles even once the child vehicles have disconnected from the modular vehicle 200. For example, as long as the child vehicles are operating using the navigational data provided by the logistical module 116, the disconnected vehicles may be deemed child vehicles in the transportation network. In another embodiment, disconnected vehicles may be deemed child vehicles for a predetermined amount of time post disconnection or for as long as the disconnected vehicles are operating within a predetermined radius of the parent vehicle 208.

Returning to the example, the logistical module 116 may determine a more efficient way to deliver cargo and/or vehicle occupants to different addresses in the city based on the vehicle data and the user data. For example, suppose the a first vehicle 400 shown in FIG. 4, a second vehicle 500 shown in FIG. 5, and a third vehicle 600 shown in FIG. 6, are traveling to two different addresses city from different surrounding areas.

Once the vehicles 400, 500, and 600 are connected, electrically or physically, to the parent vehicle 208, the logistical module 116 may determine a path plan that includes deployment of specific child vehicles. For example, suppose the first vehicle 400 and the second vehicle 500 are traveling to a first address and the third vehicle 600 is traveling to a second address. The logistical module 116 may determine that it is not necessary for both the first vehicle 400 and the second vehicle 500 to travel to the first address. Instead, the logistical module 116 may determine that any cargo or vehicle occupants traveling to the first address should be moved to the first vehicle 400, which will travel to the first address. Accordingly, the logistical module 116 may determine a more efficient or convenient path for the child vehicles of the modular vehicle 200.

Deployment occurs when the child vehicle disconnects from the modular vehicle. 200 to travel the planned path independently. Deployment may occur while the modular vehicle 200 is stopped or is in motion. The path plan of the logistical module 116 may also include a deployment time and/or a deployment place for the child vehicles. As discussed above, when connected to the modular vehicle 200, the first vehicle 400, the second vehicle 500, and the third vehicle 600 are deemed child vehicles. Continuing the example from above, suppose that according to the path plan the first vehicle 400 is to travel with the modular vehicle 200 until a first time at which point the first vehicle 400 is to disconnect and be deployed to follow a first set of directions to the first address. The path plan may also include the second vehicle 500 staying connected to the modular vehicle 200 for an unspecified amount of time until such time that the second vehicle 500 is needed. Likewise, according to the exemplary path plan the third vehicle 600 is to travel with the modular vehicle 200 until a second time at which point the third vehicle 600 is to disconnect and be deployed to follow a second set of directions to the second address. The path plan is transmitted to the vehicles 400, 500, and 600 as navigational data. For example, the navigation data may be transmitted using the transmitter 300 of the parent vehicle 208. Accordingly, the child vehicle can use the navigational data to navigate the planned path even when the child vehicle is operating independently of the modular vehicle 200.

The path plan generated by the logistical module 116 is dynamic and may change as new vehicles connect to the modular vehicle 200 or as vehicles request to join the modular vehicle 200. For example, suppose that the first vehicle 400 and the second vehicle 500 are connected to the parent vehicle 208, collectively being a modular vehicle 200. A first path plan may be provided for the first vehicle 400 and the second vehicle 500. Suppose that the third vehicle 600 joins the modular vehicle after the first path plan is generated. The logistical module 116 may generate a second path plan with updated navigational data based on the vehicle and/or user data of the third vehicle 600. Accordingly, when a subsequent child vehicle connects to the parent vehicle via the modular vehicle, the logistical module 116 transmits updated navigational data to the child vehicles. In some embodiments, the navigational data may direct the child vehicle to another parent vehicle.

Alternatively, the logistical module 116 may update the planned path based on a detour to join with the proximate vehicle 214. The logistical module 116 may also schedule a detour to accommodate vehicle occupants, emergencies, weather conditions, incident reports, traffic concerns, etc. Returning to the example from above, suppose that the path plan included traveling to a deployment place to deploy the first vehicle 400 at a first time before the second time. Further, suppose that a traffic conditions make it difficult to proceed to the deployment place. The logistical module 116 may update the path plan to shuffle the destinations. For example, the updated path plan may include proceeding to a detour place to deploy the third vehicle 600 at a third time that is before the second time to deploy the third vehicle 600, and returning to the deployment place to deploy the first vehicle at a fourth time, later than the third time.

Moreover, the logistical module 116 may modify the planned path while the modular vehicle 200 is traveling. Continuing the example above, suppose the vehicle occupant 502 would like to stop at waypoint. The logistical module 116 may schedule the modified route to accommodate a waypoint request based on approval, availability, user data, and vehicle data among others. For example, the logistical module 116 may determine the logistical effects (e.g., the additional time, additional distance, fuel, charge, etc.) of accommodating the waypoint request and may either update the path plan to accommodate the waypoint request or deny the waypoint request based on the logistical effects satisfying one or more thresholds. For example, the logistical module may approve the waypoint request of the updated path plan if the estimated time of arrival of the first vehicle 400 at the first address does not change even if the updated path plan has the first vehicle 400 traveling a longer distance. Therefore, the logistical module 116 may assess the effects of a waypoint request for the child vehicles individually.

The charging module 118 of the processor 104 uses the charging system 126 to provide a charge the first child vehicle 210 and the second child vehicle 212.

In one embodiment, a parent vehicle 208 of the modular vehicle 200 is connected to a charging source 302. The charging source 302 may be the parent vehicle 208 of the modular vehicle 200. In another embodiment, a charge from the charging source 302 may be routed through the parent vehicle 208. The charging source 302 may also be remotely located from the parent vehicle 208. For example, the charging source 302 may be provided through infrastructure, such as the roadway 206, solar powered vehicle systems (not shown), etc.

The charging systems 126 may manage the charge delivery from the charging source 302 to the child vehicles. For example suppose the first vehicle 400 is a child vehicle using a first charging platform (e.g., analog current charge) and the second vehicle 500 is a child vehicle using a second charging platform (e.g., super-fast direct current charge). The charging system 126 modulates the charge to deliver charge in the appropriate form to the first vehicle 400 and the second vehicle 500. The charging systems 126 manage the charge based on charging information received from the charging module 118.

The charging module 118 may receive the charge information about the current charge status of the child vehicles, such as the first child vehicle 210 and the second child vehicle 212. For example, the charge information may include the current charge level or the predicted charge level of the first child vehicle 210 and the second child vehicle 212may be received. The charging information may also include how efficiently the first child vehicle 210 and the second child vehicle 212 is able to be charged, how efficiently the available mobility device stays charged, the charge rate, charge usage rate, and the charge usage rate based on different functionality or modes, among others. The charging information may further include timing information related to charging, for example, the amount of time needed to change given different types of charging platforms.

Based on the charging information, the charging module 118 determines charging data, such as the amount of time necessary to fully charge the child vehicle, range information given a current charge, charging alerts, etc. The charging module 118 may also determine whether there is sufficient time to charge the child vehicle. For example, executing the path plan may require that the child vehicle have a threshold charge level. The threshold charge level may be a total charge, for example, a 100% charge. The threshold charge level may be calculated based on one or more of the navigational data, vehicle data, the user data, and/or the logistical effects. The threshold charge may be additionally based on supplemental information extracted from other sources such as the central hub database 134. For example, the central hub database 134 may store metrics related to charging based on historical data.

In another embodiment, the threshold charge level may be a static determination. For example, charging module 118 may initiate charging child vehicles when the child vehicle is connected to the modular vehicle 200. In another embodiment, the charging module 118 may initiate a charge based on a request from the child vehicle. For example, suppose that the first vehicle 400 connects to the parent vehicle 208. The first vehicle 400 may request to be charged through the parent vehicle 208. The charging module 118 may request remuneration for charging services. For example, the parent vehicle 208 and first vehicle 400 may establish a pecuniary arrangement. For example, the first vehicle 400 may pay the parent vehicle 208 for the services being provided to the first vehicle, such as the charging. Additionally or alternatively, the first vehicle may pay for the navigational data. The pecuniary arrangements may include business parameters may include the rates of payments (e.g. an amount of payment per time (e.g., minute, hour, etc.), amount of payment per distance (e.g., mile, kilometer, etc.), flat rate, etc.), payment details, how payment is made (e.g., credit card, through a vehicle payment system, payment applications, etc.), when the payment will be made including whether a deposit is required, how a receipt is received, among others.

The notification module 120 provides notifications to users (e.g., vehicle occupant, person using the transportation to deliver or receive cargo, etc.) regarding the planned path determined by the logistical module 116. For example, returning to the example from above, the logistical module 116 may determine that any cargo or vehicle occupants traveling to the first address should be moved to the first vehicle 400 which will travel to the first address. Because the path plan includes a vehicle occupant moving from one child vehicle to another child vehicle, the notification module 120 provides the vehicle occupant 502 with a notification to move from the second vehicle 500 to the first vehicle 400. For example, suppose that the first child vehicle 210 is unable to execute a particular route when connected to the parent vehicle 208 due to low charge, a vehicle occupant 218 can be directed to enter the second child vehicle 212 that has sufficient charge using a notification. Therefore, the users may be notified when cargo or vehicle occupants are redistributed in the modular vehicle 200.

In another embodiment, the notification may include other information regarding the navigational data generated by the logistical module 116. For example the notification data may include estimated time of arrival, logistical effects, and updates to the navigational data, among others. For example, the notification may be delivered using the vehicle systems 122 and/or the portable device 138 of the one or more child vehicles. The notification may be an auditory signal, a vibrational signal, a visual signal, a text message, an electronic mailing, or a push notification, among others.

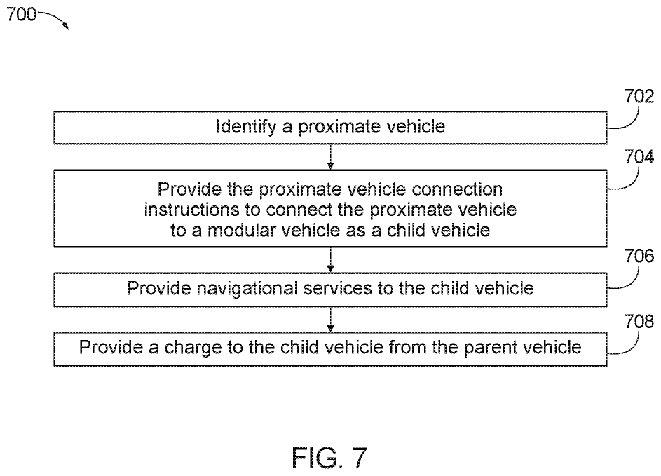

FIG. 7 is a process flow diagram of a method for providing a transportation network. The transportation network may provide networked transportation for child vehicles accessing a parent vehicle of a modular vehicle. It is understood that the illustrative examples discussed herein are exemplary in nature and that varying parent vehicles, child vehicles, and connection instructions can be implemented.

At block 702, the method 700 includes identifying a proximate vehicle. The proximate vehicle 214 may be identified as a proximate vehicle using data received from the vehicle systems 122 and the vehicle sensors 128. In another embodiment, the proximate vehicle 214 may be identified by a request transmitted from the proximate vehicle 214 received, for example, via the network 136. In one embodiment, the central hub database 134 may manage the transportation network through an app that users can access on a portable device 138. The app may allow users to request to utilize the transportation network, for example, to request to join the modular vehicle 200. The app gives the users the arrival time and options for their travel such as fewer stops, shortest route, etc.

At block 704, the method 700 includes providing the proximate vehicle 214 connection instructions to connect the proximate vehicle 214 to the modular vehicle 200 as a child vehicle. The connection instructions to directly or indirectly connect the proximate vehicle 214 to a parent vehicle 208 of the modular vehicle 200. For example, the proximate vehicle 214 may connect to the parent vehicle 208 by way of a child vehicle. The connection instructions provide information for the proximate vehicle 214 to join the modular vehicle 200 in the member portion 204 as a child vehicle. The connection instructions may include, for example, driving parameters such as a steering angle, a braking force, parent vehicle velocity, proximate vehicle velocity, following distance of the proximate vehicle 214, etc.

At block 706, the method 700 includes providing navigational services to the child vehicle. The navigational services may include path planning that determine the manner in which the parent vehicle 208 and the one or more child vehicles, such as the first child vehicle 210 and the second child vehicle 212, travel routes to destinations. In particular, the path planning may include generating navigational data and providing the navigational data to the child vehicles even when disconnected. Furthermore, the navigational data may be provided to users including vehicle occupants and persons using the modular vehicle 200 deliver and or receive cargo, as notifications.

At block 708, the method 700 includes providing a charge to the child vehicle from the parent vehicle 208. The charge may be delivered to the one or more child vehicles from the parent vehicle 208 that is either the charging source 302 or connected to the charging source 302. The charging may be managed and delivered by charging systems 126 that may be hosted by the parent vehicle 208 or distributed over the one or more child vehicles.

Therefore, modular vehicle 200 allows autonomous child vehicles, such as the first child vehicle 210 and the second child vehicle 212, to connect and disconnect while the modular vehicle 200 is in motion. The modular vehicle 200 provides a transportation network by virtue of the VCD 102. For example, using the VCD 102 the modular vehicle 200 provides services to the independent child vehicles 210 and 212. The modular vehicle 200 provides navigational data and charging to the child vehicles 210 and 212. The modular vehicle 200 is connected to a charging source 302, allowing the child vehicles 210 and 212 to recharge when the child vehicles are connected to the modular vehicle 200. Moreover, vehicle occupants may be prompted to move from one child vehicle to another child vehicle according to a path plan to increase the efficiency of the routes and deliver vehicle occupants to their desired destinations, rather than predetermined stop, without having to make multiple stops, thereby improving the vehicle occupant's experience.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A transportation network system for providing a modular vehicle having a parent vehicle and one or more child vehicles, the transportation network system comprising:
a connection module configured to identify a proximate vehicle and providing the proximate vehicle with connection instructions to connect the proximate vehicle to the parent vehicle as a child vehicle;
a logistical module configured to provide services to the child vehicle; and
a charging module manages a charging source and is configured to facilitate a charge to the child vehicle from the charge source through the parent vehicle.

2. The transportation network system of claim 1, wherein the connection module is further configured to transmit a connection signal to trigger a central hub database to transmit the connection instructions to the proximate vehicle.

3. The transportation network system of claim 1, wherein the connection instructions include one or more driving parameters and a docking procedure.

4. The transportation network system of claim 3, wherein the docking procedure includes timing for executing a mating procedure using a connection assembly of the proximate vehicle and the modular vehicle.

5. The transportation network system of claim 1, wherein the services provided by the logistical module includes path planning, and wherein the path planning is provided to the child vehicle as navigational data for a planned path.

6. The transportation network system of claim 5, wherein a subsequent child vehicle connects to the parent vehicle via the modular vehicle, and wherein the logistical module transmits updated navigational data to the child vehicle based on vehicle data associated with the subsequent child vehicle.

7. The transportation network system of claim 5, wherein the navigational data supports the child vehicle navigating the planned path when the child vehicle is operating independently of the modular vehicle.

8. The transportation network system of claim 1, wherein the charging module is configured to receive charging information from the one or more child vehicles, generate charging data based on the charging information, and initiate charging for the one or more child vehicles.

9. The transportation network system of claim 1, further comprising:
a notification module configured to provide a vehicle occupant with a notification associated with navigational data generated by the logistical module.

10. The transportation network system of claim 9, wherein the one or more child vehicles includes a first vehicle and a second vehicle, and wherein the notification is directed to having a vehicle occupant or cargo move from the first vehicle to the second vehicle.

11. A transportation network system for providing a modular vehicle having a parent vehicle and one or more child vehicles, the transportation network system comprising:
a connection module configured to identify a proximate vehicle and providing the proximate vehicle with connection instructions to connect the proximate vehicle to the parent vehicle as a child vehicle;
a logistical module configured to provide services to the child vehicle and generate navigational data for the child vehicle; and
a charging module connected to a charging source and configured to initiate a charge to the child vehicle from the charging source.

12. The transportation network system of claim 11, wherein the connection instructions include one or more driving parameters and a docking procedure.

13. The transportation network system of claim 11, wherein the services provided by the logistical module includes path planning, and wherein the path planning is provided to the child vehicle as navigational data.

14. The transportation network system of claim 11, wherein the navigational data supports the child vehicle when the child vehicle is operating independently of the modular vehicle.

15. The transportation network system of claim 11, wherein the parent vehicle is the charging source.

16. A transportation network method for providing a modular vehicle having a parent vehicle and one or more child vehicles, the transportation network method comprising:
identifying a proximate vehicle;
providing the proximate vehicle with connection instructions to connect the proximate vehicle to the modular vehicle as a child vehicle;
providing navigational services to the child vehicle; and
providing a charge to the child vehicle from the parent vehicle.

17. The transportation network method of claim 16, wherein the navigational services include performing path planning and providing the child vehicle with navigational data.

18. The transportation network method of claim 17, wherein a subsequent child vehicle connects to the parent vehicle via the modular vehicle, and further comprising transmitting updated navigational data to the child vehicle based on vehicle data associated with the subsequent child vehicle.

19. The transportation network method of claim 17, further comprising:
a notification module configured to provide a user with a notification associated with the navigational data.

20. The transportation network method of claim 16, further comprising receiving charging information from the one or more child vehicles, generate charging data based on the charging information, and initiate charging for the one or more child vehicles.
